(19) United States
(12) Patent Application Publication
(10) Pub. No.: US 2009/0112708 A1
(43) Pub. Date: Apr. 30, 2009

(54) Mobile Content Placement Reward System

(76) Inventors: William J. Barhydt, Los Gatos, CA (US); Sanjeev Bhalla, Sunnyvale, CA (US); Jiawen Su, Sunnyvale, CA (US); Gagan Palrecha, Plymouth, MI (US); Woon Shing Chan, Monterey Park, CA (US)

Correspondence Address: FISH & RICHARDSON P.C., P.O. BOX 1022, MINNEAPOLIS, MN, 55440-1022, US

(21) Appl. No.: 11/926,707

(22) Filed: Oct. 29, 2007

(51) Int. Cl. G06Q 30/00; H04Q 7/20

(52) U.S. Cl. 705/14; 455/466

(57) ABSTRACT

The present invention is generally directed toward a system and methods of placing content, including advertising, content on a mobile device in response to an event in the operational lifecycle of the device. The event defines an opportunity between power-up and power-off when the user's attention is likely drawn to the device. The inserted content can be any media form including graphic, image, video, animation, audio or textual and can be fully interactive. The content is inserted before, during, or after an event in a minimally intrusive manner so as not to interfere with the communications features of the device. The system and method reward the user for each display of content.

### TECHNICAL FIELD

The present invention generally relates to systems and methods for content placement in the mobile environment and associated user incentives.

### BACKGROUND

Content, and specifically advertising content, has previously been presented to mobile device users either as part of a text message or a web page configured for display on a mobile device. Text messages are limited to no more than 160 characters and are considered as an intrusive media form by many consumers. Web page browsing on a mobile device is cumbersome and less user friendly as compared to web navigation on a personal computer. The mobile device has a small screen size. It is also difficult to navigate on a screen and difficult to enter a URL address. Moreover, consumers are not accustomed to freely navigating the Internet on their mobile devices. As a result, a very small percentage of mobile device users browse the Internet from a mobile device. Because of the intrusiveness, textual limitations, low frequency of use, and cumbersome nature of the text messaging and mobile Internet access, advertisers and other content providers have not been able to fully utilize the tremendous penetration of mobile devices in the market place. Moreover, advertisers and other content providers have not been developed an effective rewards system based on marketing content placement in order to incentives the user to allow marketing content onto the mobile device and/or seek more marketing content.

As such, there is a need for a system and method of distributing content, and specifically advertising content, to mobile devices that is highly visible to the user and easy to use with the common operational features of a mobile device. There is a need for a content placement system that does not overly intrude with the user's common pattern of device use. Additionally there is a need to reward consumers who choose to view such distributed content in a manner that is more useful to the consumer.

### SUMMARY

The present invention addresses this need by providing a system and method of placing content onto a wireless device during predetermined events. These predetermined events are associated with the most common operational features of a mobile device and define a high probability when the user's attention is focused on the handset. The user can be rewarded based on the content displayed or played during the event and/or user interactivity with the content placed during the event. The reward can include additional content or services for the mobile device. The reward can be loyalty points, coupons, credits, or other activity associated with a specific or general user account.

The present invention is also directed to a computer implemented method of placing content before a user, comprising: retrieving content via a wireless communication network; storing content locally on a handset device; displaying content in response to an event; recording information associated with the content display; and transmitting the content information via a wireless communication network. The content can comprise auditory, graphic or textual information, be associated with marketing or advertising campaigns, be associated with a brand or entity, can include rich media, and be interactive. The content can be displayed according to a randomization algorithm or a just last played algorithm.

The present invention is further directed to a computer implemented method of placing content before a user, comprising: retrieving content via a wireless communication network; storing content locally on a handset device; displaying content in response to an event; recording information associated with the content display; and transmitting the content information via a wireless communication network, wherein retrieving content occurs at power-up, retrieving content occurs via a control frequency, or retrieving content occurs on a predetermined basis.

The present invention is still further directed to a computer implemented method of placing content before a user, comprising: retrieving content via a wireless communication network; storing content locally on a handset device; displaying content in response to an event; recording information associated with the content display; and transmitting the content information via a wireless communication network, wherein the event comprises a power-up display; a power-up audible alarm; a welcome screens; a ringtone; an alarm; a display during an idle handset period; a wallpaper; a status message; a user entered key stroke; receiving a telephone call, email, or SMS/MMS message; the beginning and end of a voice communication or telephone call; regular or intermittent intervals during a telephone call; sending an SMS/MMS message; sending an email; displaying an SMS/MMS message; displaying an email; inbox status displays; missed call or message displays; application initiation screens; application termination screens; power-off screens; and power-off alarms. The content information recorded can comprise content display information, display time, user interactivity, or content intrusiveness.

The present invention is still further directed to a computer implemented method of placing content before a user, comprising: retrieving content via a wireless communication network; storing content locally on a handset device; displaying content in response to an event; recording information associated with the content display; and transmitting the content information via a wireless communication network, and rewarding a user for content displayed, wherein the reward is associated with a consumer loyalty program. The reward can comprise value added to a user account.

The present invention is also directed to a system comprising: a wireless network infrastructure; a server configured to provide content and display instructions by communication via the wireless network infrastructure; a wireless device handset configured to receive content and display instructions via the wireless network infrastructure, wherein the content is displayed on the wireless handset device in response to an event.

### BRIEF DESCRIPTION OF THE DRAWINGS

FIG. 1 illustrates a prior-art SMS message screen on a mobile device;

FIG. 2 illustrates a prior-art screen shot of a WAP page;

FIG. 3 illustrates a flow chart of a prior-art process of events associated with a mobile device from power up to power off;

FIG. 4 illustrates a prior-art power-up screen on a mobile device;

FIG. 5 illustrates a prior-art screen shot of a mobile device display while idle;

FIG. 6. illustrates a flow chart of a process of events associated with a mobile device from power up to power off in accordance with an implementation of the present invention;

FIG. 7. illustrates a screen shot of a power-up display screen in accordance with an implementation of the present invention;

FIG. 8 illustrates a prior-art screen shot of a mobile device display while idle in accordance with an implementation of the present invention;

FIG. 9 illustrates a screen shot of an alert message in accordance with an implementation of the invention;

FIG. 10 illustrates a screen shot of a call summary display in accordance with an implementation of the present invention;

FIG. 11 illustrates a system architecture in accordance with an implementation of the present invention;

FIG. 12 is a flow chart of a process for managing a content placement rewards system in accordance with an implementation of the present invention;

### DETAILED DESCRIPTION

The consumer penetration of mobile devices such as cellular telephones is significantly higher than other media forms, including the Internet or World Wide Web. Mobile devices can often reach 70-80% of the population in most developed countries. The consumer penetration rate may be even higher in developing countries as mobile telecommunications systems require less infrastructure and are often cheaper to maintain than traditional fixed-line telecommunications systems. Because of the tremendous reach of mobile devices, the opportunity to distribute content, and specifically marketing and advertising content, to a larger number of people has never been greater. Mobile marketing through promotions and simple advertising campaigns takes advantage of the ubiquity of mobile devices.

Content placement, marketing and advertising on a mobile devices has become increasingly popular ever since the rise of SMS (Short Message Service) in the early 2000s. SMS, commonly referred to as text messaging, has become a legitimate advertising channel due to the fact that unlike email over the public Internet, the mobile telecommunications system operators and carriers police their own networks and enforce strict guidelines and best practices for the mobile media industry (including mobile advertising). One key criterion for provisioning is that the consumer opts in to the service. The mobile operators demand a double opt in from the consumer and the ability for the consumer to opt out of the service at any time by sending the word STOP via SMS.

Mobile short codes have been increasingly popular as a new channel to communicate to the mobile consumer. Brands have begun to treat the mobile shortcode as a mobile domain name allowing the consumer to text message the brand at an event, in a store and off any traditional media.

SMS services typically run off a short code, a 5 or 6 digit number that has been assigned by all the mobile operators in a given country for the use of brand campaign and other consumer services. The mobile operators vet every SMS application and monitor the service to make sure it does not diverge from its original service description.

SMS based mobile marketing campaigns can include a short text message soliciting a user response, such as a reply text message, or a link to a URL for the advertisement sponsor's Web or Wireless Application Protocol (“WAP”) page, discussed further below. Text messaging campaigns are limited in that they require double user opt-in, and active user participation in the form of opening the message. Moreover, SMS based mobile campaigns typically do not include any form of rich media, such as graphics, video or audio, and are limited to 160 characters of text.

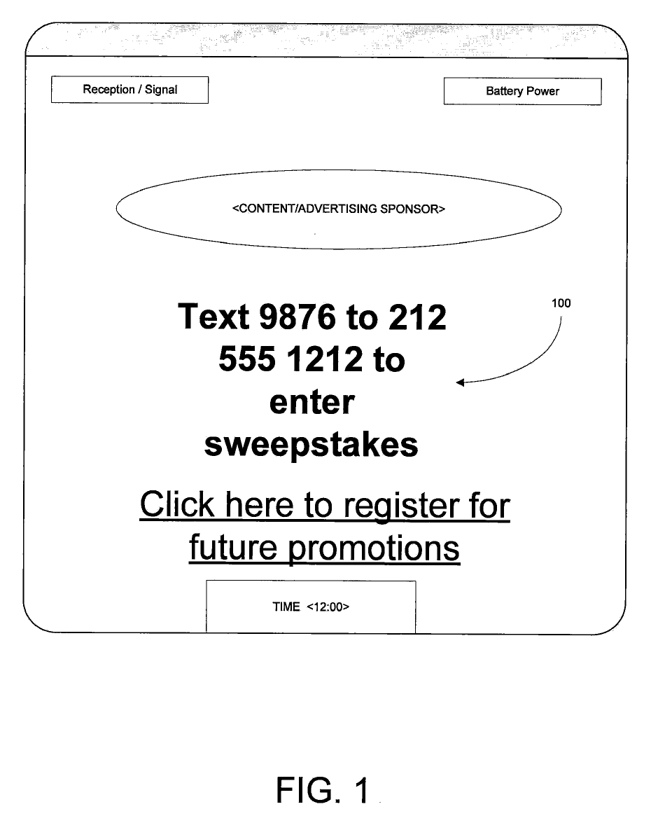

FIG. 1 illustrates a screen shot of a mobile device displaying a typical SMS advertising message. The message 100 requests the user text a campaign code, pass word, or other identifier to a telephone number or short code, such as “Text 9876 to 212 555-1212 for to enter sweepstakes.” The message 100 can identify the message sender, typically the content or advertising sponsor, such as “<CONTENT/ADVERTISING SPONSOR>.” The text message 100 can also include a link to the advertising sponsor's URL, Web page or WAP page. For example, if room is available either on the screen or by the SMS character limitation, the text may also include a secondary consumer call to action, such as, “Click here to register for future promotions.”

In addition to SMS based mobile marketing campaigns, mobile advertising and content placement campaigns can be inserted into the Mobile Internet or WAP pages. These WAP based campaigns are typically extensions of traditional Web based marketing and content placement campaigns.

Similar to Web browsers and Web site pages, mobile devices, such as cellular telephones and personal data assistants, support WAP browsers that access WAP sites. WAP is an open international standard for applications that use wireless communication. WAP's principal application is to enable access to the Internet from a mobile device. A WAP browser provides all the basic services of a computer based Web browser but simplified to operate within the restrictions of a mobile device (e.g., screen size, bandwidth limitations, mobile device computing and security limitations, etc.). A user can navigate to a WAP page by performing a traditional search using a WAP enabled search engine, entering a known URL, or following a link provided in, for example, a list of favorites, a book mark, or on a WAP page. Users may also access a WAP page through a link provided in an SMS message as described above.

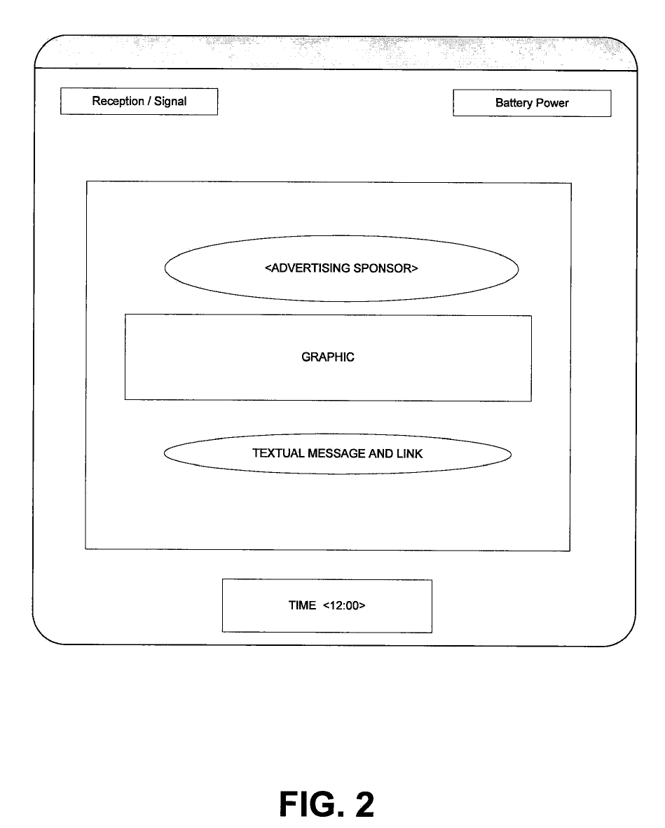

WAP pages provide advantages over SMS based marketing in that rich media may by used, such as graphics, video, animation and audio files. WAP also has limitations. A user must choose to find a WAP page by answering a consumer call to action or following a link. Also, connection to the mobile telecommunications network must also be established and maintained. Bandwidth and signal strength are further limitations. FIG. 2 illustrates a screen shot of a mobile device displaying typical WAP based advertising content.

SMS and WAP based mobile marketing can be used together as part of a larger integrated marketing campaign.

Mobile marketing to date has also had difficulty rewarding or incentivizing users to participate in mobile campaigns. Rewards and incentives have been limited to specific product offerings associated with the specific advertisement displayed, often having relevance for a short time and at a specific location. For example, an SMS advertisement may offer a free donut with the purchase of a large coffee. This incentive does not have lasting effects or benefits for the user because it is only relevant if the consumer is in the participating coffee shop. Hence, there is a need to provide a rewards system that has long lasting relevance and more general applicability to the consumer.

Advertising and marketing in more traditional media forms, such as television, radio, print media, and increasingly the internet provide this longer term relevance by offering reduced cost services and content for the insertion of advertising content. For example, broadcast television is free because of commercial sponsors.

But mobile telecommunications has already been established as a consumer paid service. It will be sometime before advertising and marketing content offset or fully subsidize mobile services and content.

A need exists for a convenient mechanism that delivers relevant content to consumers on mobile devices that overcomes the shortcomings of SMS and WAP based mobile marketing campaigns. Additionally, there is a need to provide a long term incentive to consumers to accept mobile marketing and advertising content on their mobile devices. In accordance with various implementations of the present invention, the limitations of previous mobile marketing attempts are overcome by systems and methods for placing content on a cellular device during times when the user's attention is naturally drawn to the device and then rewarding the user for viewing and interacting with the advertising content

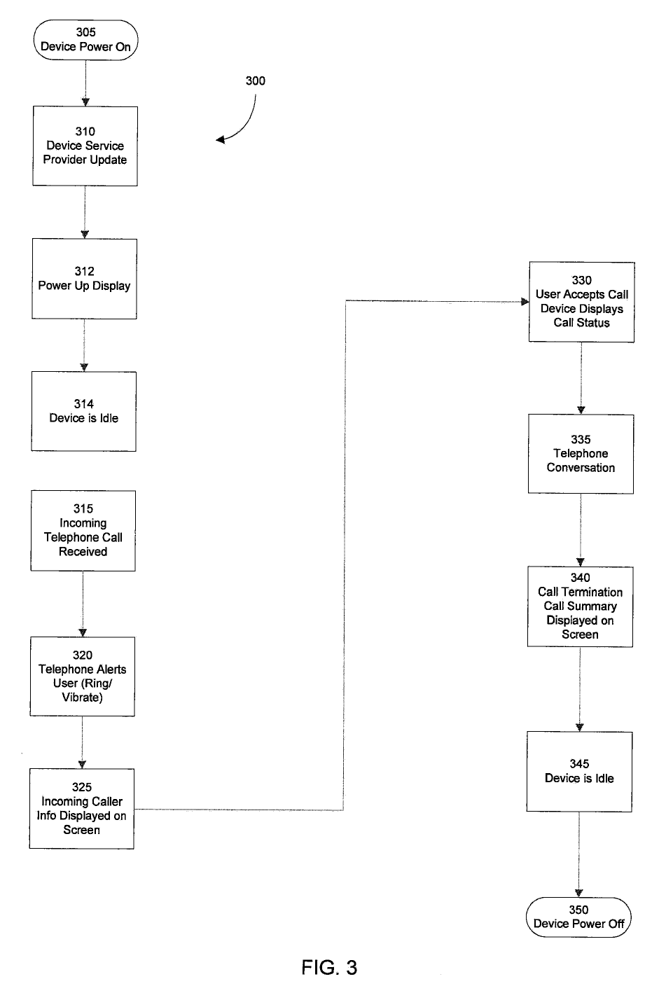

FIG. 3 is a flow chart of a process 300 depicting a sequence of events associated with a mobile device between power-up and power off. Upon activation 305 or power-up of the mobile device, the handset typically makes a connection with a wireless telecommunications infrastructure to receive operating instructions and update 310 the handset status. For example, when a user first powers-up a cellular telephone, the handset waits to receive a signal, often on a control channel, from the mobile telecommunications infrastructure. The signal contains a System Identification Code (SID)—a unique 5-digit number that is assigned to each mobile carrier by the FCC. The control channel is a dedicated frequency used by the handset and the mobile telecommunicating infrastructure base station that facilitates various working functions such as call set-up and channel changing. If the handset does not receive an SID signal on a control station, the handset typically displays a message indicating that the handset is out of range or no service is available.

Upon receiving the SID, the handset compares the received SID to the SID programmed into the handset, typically by the service provider/carrier or handset manufacturer. If the SIDs match, the handset is operating within a carrier supported network. If the SID's do not match, the phone may operate on a third party network, though additional charges may apply.

Along with the SID, the handset also transmits a registration request identifying the handset with its specific location relative to a cell within the mobile telephony infrastructure. Registration is typically with a Mobile Telephone Switching Office (“MTSO”). The MTSO registers the handset with the cell it is operating from and, coordinating with one or more base stations, tracks the signal strength from the handset in a database. The MTSO communicates with the handset over the control channel to give instructions regarding which frequency or frequency pairs to use in order to place or connect a call. If the signal is low, the MTSO and base stations can send an instruction over the control channel to switch the handset to an adjacent cell with a higher signal.

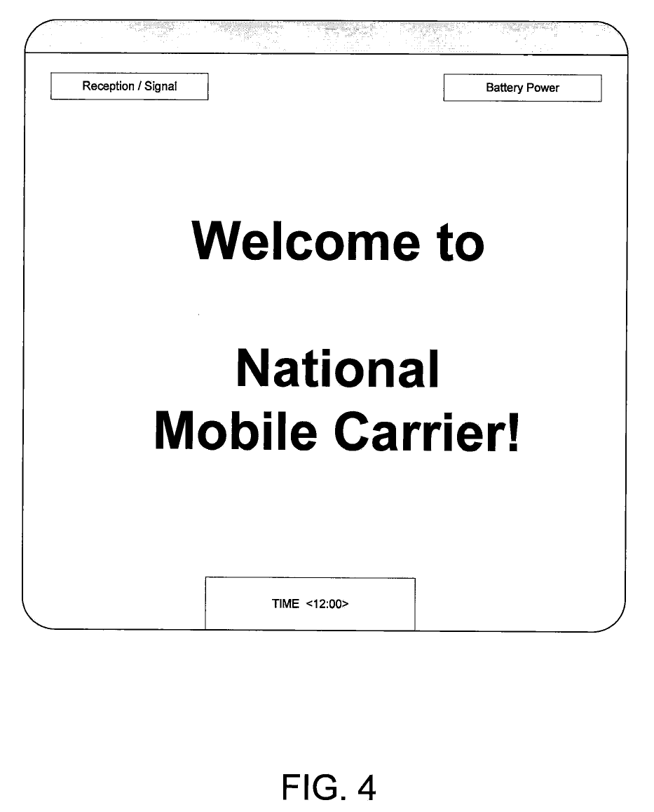

During power-up 305 and handset status update 310, the handset may utilize a power-up display 312 and/or an audible signal to notify the user that the handset has been turned on and is attempting to connect with the mobile telephony infrastructure. FIG. 4 illustrates a screen shot of a typical power-up display. During this time, the user's attention is often focused on the handset display as the user waits for confirmation that the device is on and connected with an acceptable signal and power strength.

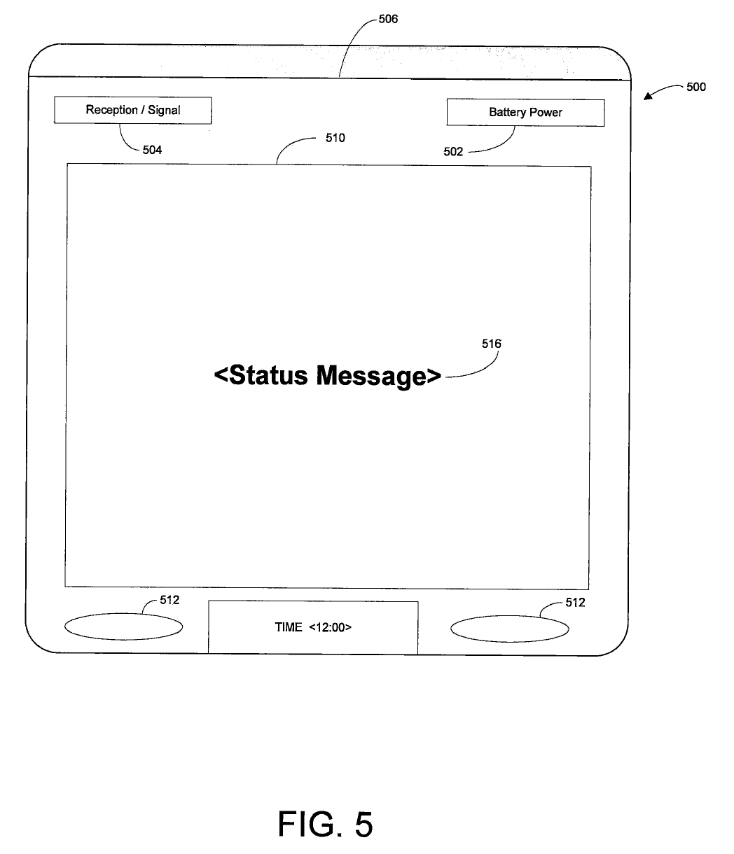

After receiving the control instructions and registering with the mobile telecommunications infrastructure, the handset will sit idle 314 until an incoming transmission is received, the connection signal drops below an acceptable level, the battery power diminishes, or the user initiates an application or other event on the handset. Although the handset is idle, the user may from time to time focus his attention to the handset, for example, to check the local time, check battery power level, check connection strength, or check inboxes for messages or missed calls. FIG. 5 illustrates a screen shot 500 of a typical idle phone display, including Battery Power Indicator 502, Reception/Signal Indicator 504, Time Display 506, Wallpaper 510, Menu Buttons 512 and one or more Status Messengers 516. Wallpaper 510 may be any graphic or color scheme applied to the background of the display, as is known in the art. Menu Buttons 512 are typically graphic user interface (“GUI”) buttons linking to system menus, contact folders, or other application folders, as is known in the art. One or more Status Messages 516 indicate to the user the status of various handset or wireless service features, for example, status calls, alarms, etc., and may be text or a GUI icon.

Upon receiving an incoming call 315, the handset than alerts the user 320 that an incoming call is pending. The alert 320 is typically in the form of an audible alarm such as a ring or ring tone. Ring tones can be customized depending on user preferences or information associated with the incoming call Such as caller ID. Alternatively, the alert 320 may be a visual signal such as a graphic display, indicator light, or may be a physical vibration of the handset. Typically, with any alert, the user's attention is drawn to the handset both audibly and visually. Often additional non-user individuals' attention may be drawn to the alert as well.

Simultaneously with the alert 320 the handset also displays information 325 associated with the incoming call. The displayed information 325 can include caller identification such as caller telephone number, caller name, caller contact information, time the call is made, location from which the call is made, and whether the caller is within a user network, carrier plan, or from a trusted or validated source. Again, upon receiving the display information 325, the user's attention is typically focused on the handset display screen.

Having been alerted 320 to the incoming telephone call and received display information 325 associated with the caller, the user can accept 330 or answer the incoming call and typically places the handset to the user's ear. Thus the user's attention is focused on the handset and specifically the earpiece or speaker.

After accepting and while the connection is maintained between the handset and the mobile telephone infrastructure, the handset displays the call status 330. The user may refer to the call status display to adjust volume, confirm signal strength, battery power, connection time, or local time. This represents an additional period when the user's attention is focused on the handset and more specifically on the display.

During the telephone conversation 335 the user's attention is typically focused on the ear piece or speaker. The handset is also typically held to the ear so that third person's viewing the user can clearly see the display screen external to the handset. This represent a period when third parties' attention may be focused on the handset.

After completion of the call, the user terminates the call 340. Call summary information is typically displayed 340 including duration of call and options to add or update the call contact information into a locally stored address book or database. At call completion 340, the user's attention is typically focused on the handset display. Moreover, just after termination of the call, the user's attention may momentarily remain focused on the ear piece or speaker of the handset.

Following termination of the call 340 the handset typically will sit idle 345 until an additional call is received or until the user interacts with the telephone. The user often checks the handset display during the idle period 345 for such information as, local time, message status, inbox status, missed calls, signal strength, and battery power. During these visual inspections for status information, the user's attention is again focused on the handset display.

Finally, at some point the user can choose to power-off 350 the handset. Alternatively, after a preset length of time without activity, or after having a low or no signal for a predetermined length of time, or after reaching a minimum battery power level, the handset may power-off 350 automatically. Upon power off 350, typically an audible signal is made indicating the handset is turning off. A display conveying power-off may also be made. At power-off 350 the user's attention is again typically focused either on the display or audibly to the audible power off signal.

It has been found that during each event in the typical sequence of events on a handset between power-up and power-off the user's attention is naturally drawn to the handset. This represents one or more opportunities to place advertising content, either visually or audibly, in front of the user, thereby increasing the chances that the user will see and interact with the advertisement. Exemplary events suitable for insertion of advertising content include: power-up displays; power-up audible alarms; welcome screens; ringtones or alarm sounds played by the handset; displays during idle handset periods; wallpapers; status messages; user entered key strokes such as dialing a number; receiving a telephone call, email, or SMS/MMS message; the beginning and end of a voice communication or telephone call; regular or intermittent intervals during a telephone call; sending an SMS/MMS message; sending an email; displaying an SMS/MMS message, displaying an email; inbox status displays; missed call or message displays; before, during, and after the use of an application or auxiliary program on the handset; power-off screens; and power-off alarms. As used herein, auxiliary programs are device applications used by the user other than the primary communications applications of the handset, and include, without limitation, calendar functions, contact lists, web browsers, GPS navigation systems, games, video files, audio files, MP3 files, and the like.

In an implementation of the present invention, a content placement engine is installed on the wireless device handset. The content placement engine displays, sounds, or executes content at one or more events in the operating lifecycle of a handset between power-up and power-off of the device. The events define periods or occurrences in such a lifecycle when the user's or a non-user's attention is typically focused or drawn to the handset. The content can be advertising or marketing content.

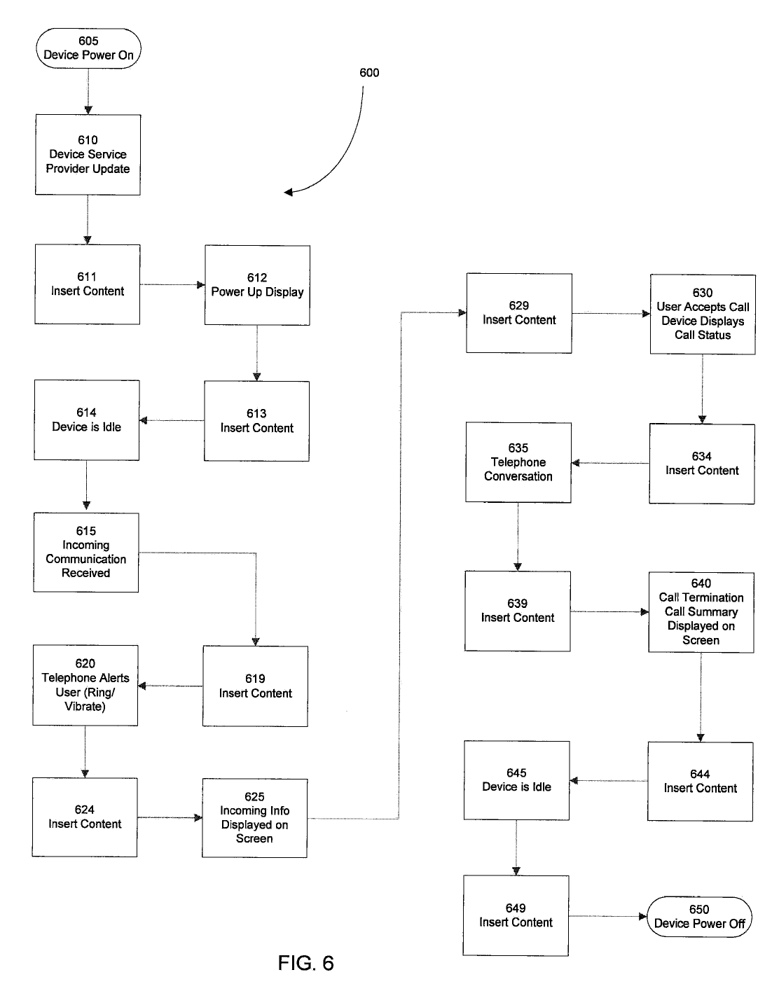

FIG. 6 is a flow chart of an implementation of a process 600 for inserting content during an event on a mobile device. The content is inserted into one or more events in the operational lifecycle of the mobile device handset from power-up 605 to power-off 650. Management and insertion of content during device events is accomplished with an installed content placement engine stored in local memory on the mobile device.

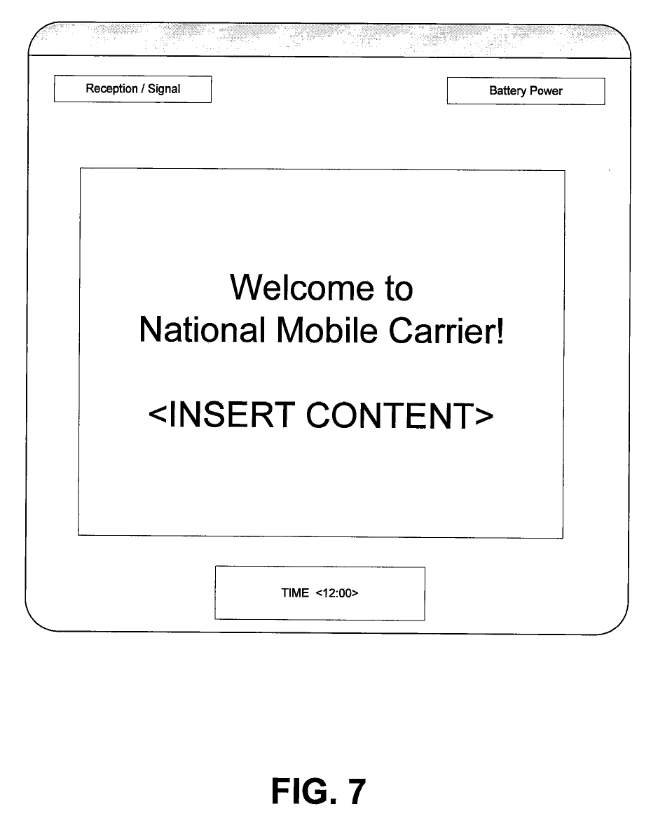

During or simultaneously with power-up 605 and handset status update 610, the handset may utilize a power-up display 612 and/or an audible signal to notify the user that the handset has been turned on and is attempting to connect with the mobile telephony infrastructure. The content placement engine inserts 611 one or more pieces of content such as a specialized ring tone, graphic display, or textual message into the power-up display 612 or power-up audible alarm. It will be appreciated that a graphic display refers to images, graphics, video, animation, photography, and the like. FIG. 7 is an exemplary screen shot of a power-up display containing content placed on the power-up display.

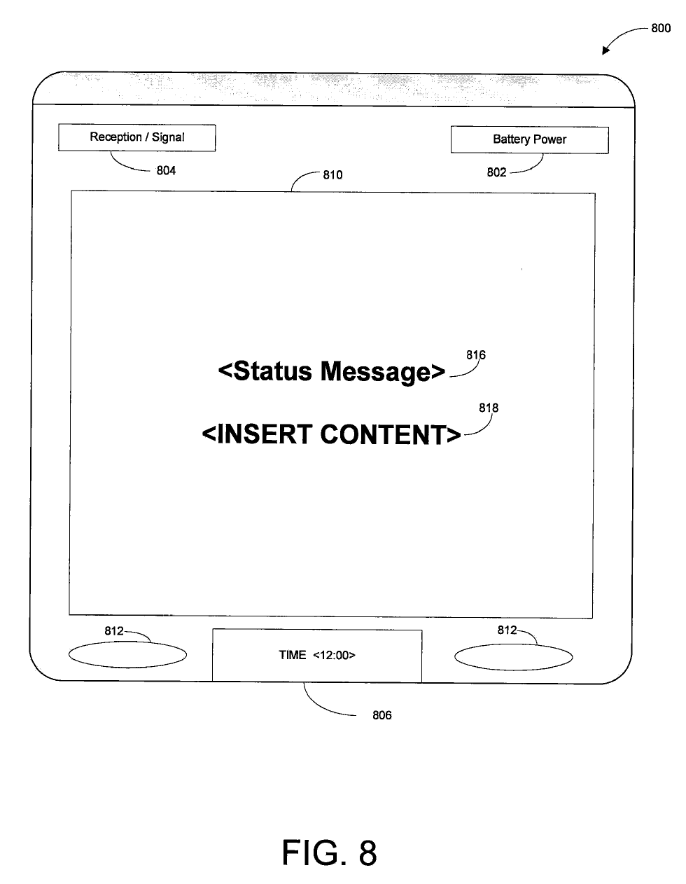

After start-up 605 and device service provider update 610 the handset may sit idle 614 until an incoming transmission is received, the connection signal drops below an acceptable level, the battery power diminishes, or the user initiates and event, such as a communication feature or an auxiliary application on the handset. The installed content placement engine inserts content in the form of graphics, video, wallpaper, or textual messages into the idle display screen. FIG. 8 illustrates a screen shot 800 of an idle display screen with content inserted including: Battery Power Indicator 802, Reception/Signal Indicator 804, Time Display 806, Wallpaper 810, Menu Buttons 812, one or more Status Messages 816, and inserted content 818. Wallpaper 810 may be any graphic or color scheme applied to the background of the display, and can include inserted content from the content placement engine. Menu Buttons 812 are typically graphic user interface (“GUI”) buttons linking to system menus, contact folders, or other application folders, as is known in the art. One or more Status Messages 816 indicate to the user the status of various handset or wireless service features, for example, status calls, alarms, etc., and may be text or a GUI icon. Status messages 816 can include content placed by the content engine, for example, “sNew Message in Inbox—Brought to you by <Ad Sponsor>.” The content placement engine can insert content 818 unassociated with wallpaper 810 or status message 816. Content inserted into wallpaper 810, status message 816, or other inserted content 818 may be any form of graphical or textual information, may be interactive, and may include one or more forms of rich media. Inserted content 818 may include audile information played periodically during the idle period 614 of the handset.

Upon receiving an incoming communication 615, the content placement engine inserts content 619 before the handset alerts 620 the user that an incoming communication is pending. The incoming communication can be an incoming telephone call, SMS/MMS message, e-mail, or other communication. The inserted content can be in the form of a unique audible alert, such as a brand jingle, a song, or a spoken phrase. The inserted content 619 can replace the traditional audible alert 620 or be in conjunction with the traditional audible alert. For example, the user's preset ring tone associated with a specific call could play just after a short brand jingle.

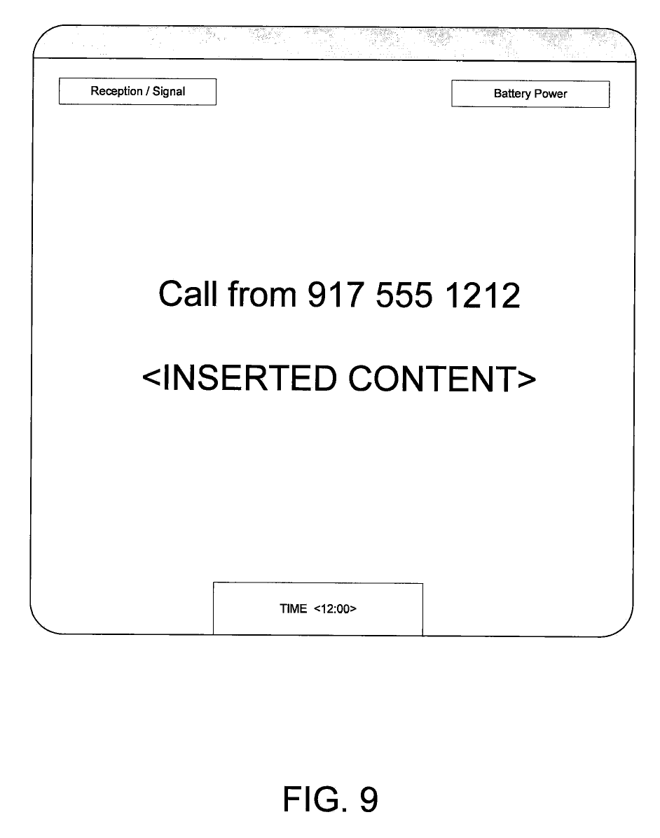

Simultaneously with the alert 620 the content placement engine inserts content 624 for display with the incoming communication display 625. The displayed information 625 can include caller identification such as caller telephone number, caller name, caller contact information, time the call is made, location from which the call is made, and whether the caller is within a user network, carrier plan, or from a trusted or validated source. The inserted content 624 can include graphical or textual content in addition to the typical incoming communication information. FIG. 9 illustrates an exemplary alert display containing inserted content.

Having been alerted 620 to the incoming telephone call and received display information 625 associated with the incoming communication, the user can accept 630 or answer the incoming communication by either opening the new message or email or answering the call. The content placement engine inserts 629 content before the message or email is opened or the call connection is made. The inserted content 629 can be in the form of an audible jingle, song, or spoken message or a graphical or textual display on the handset display screen

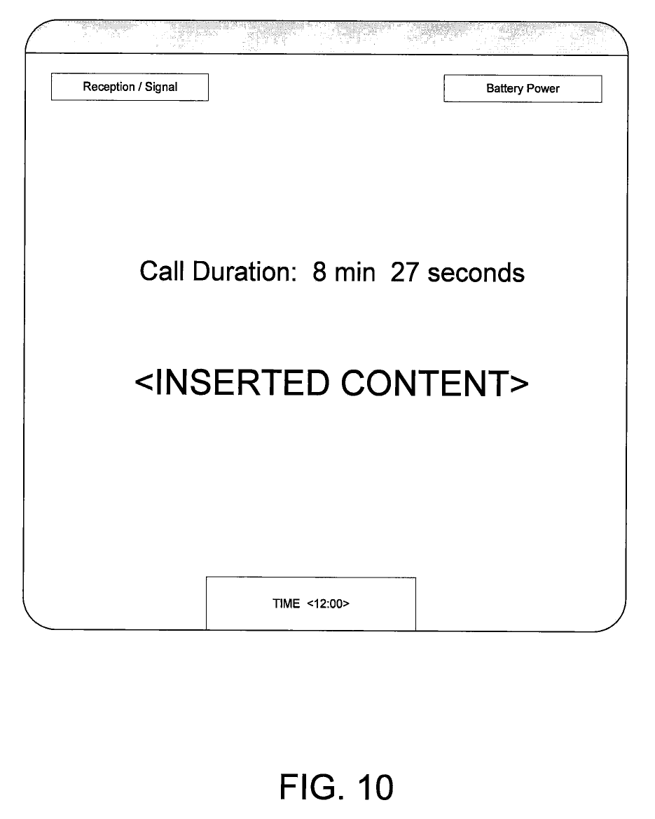

If the incoming communication is a telephone call, the handset typically displays the call status 630 during the telephone conversation 635. Content may be inserted 629 directly to the content status display screen. FIG. 10 illustrates a screen shot of a call status display with inserted content. Alternatively, content may be inserted 634 before, during, and immediately following the telephone conversation. The inserted content 629 for the call status display 630 or the inserted content 634 during the telephone conversation 635 may be audible, graphical or textual information. The inserted content 629 and 630, may be displayed on the one or more displays of the handset, such as the main display and the external display. The inserted content 629 and 630 may be displayed or audibly played for the handset user alone, or for the third party connected to the user's handset, such as the party on the other end of the telephone conversation. For example, during a telephone conversation, the inserted content 629 may display the same or different advertising message on the handset displays of both parties of the telephone conversation. For example, during a telephone conversation, both parties of the conversation may hear a spoken message before, during and after the conversation.

The incoming communication is completed. Call summary or message summary information can be displayed 640 after completion of the incoming communication, including duration of call and options to add or update the call contact information into a locally stored address book or database. The content placement engine can insert content 639 for display with the call summary information displayed at 640 in a manner similar to those previously described. Inserted content 639 can be audible, graphical or textual information. FIG. 10 illustrates an exemplary call summary display with content inserted.

Following termination of the call 640 the handset typically will sit idle 645 until an additional communication is received or until the user interacts with the handset. The content placement engine can insert content 644 into the idle display screen similar to the idle event 614 illustrated in FIG. 8. The inserted content 644 can be audible, graphical, and/or textual information.

Upon power off 650, typically an audible signal is made indicating the handset is turning off. A display conveying power-off may also be made. The content placement engine can insert content 649 to audibly play at power-off and/or display on the device display screen during power-off as previously described.

The events described herein suitable for content insertion are exemplary and not intended to be limiting. Other examples of events on the handset that may be suitable for content insertion include one or more auxiliary applications on the handset, such as, device navigation screens such as application menus, start-up and shut-down of installed applications such as contact lists, calendars, games, video applications, audio file applications, MP3 file applications, GPS navigation features, web navigation features, and/or web search engines. Co-pending U.S. patent application entitled Mobile Stored Value Transfer System, U.S. application Ser. No. ______ (Attorney Docket No. 22573-005001), filed Oct. 29, 2007, and incorporated herein by reference, describes an exemplary user auxiliary application suitable for content placement at start-up of the application, during use of the application, and at shut-down of the application.

It will be appreciated that the content inserted by the content placement engine before, during, or after any of the aforementioned events in the operational lifecycle of a mobile device can include any form of audible, graphical (including images, graphics, video and animation), or textual information. The content can be interactive, include a consumer call to action, be identified with a brand or product, be associated with an entity, and/or be informational such as current events, weather, reminders, etc. One or more types of audible, graphical, or textual content may be inserted at any event. The content may be time sensitive accounting for relevance during certain hours of the day. The content may be location sensitive, accounting for the geographic location or particular cell location of the handset. The content may be targeted to the user based on a user profile. The content may be targeted based on user interactivity with past inserted content.

The inserted content can be displayed at one or more events or all events. The inserted content can be inserted into any one or more events based in part on the content type, e.g., audible tone, graphical (including images, graphics, video and animation) information, or textual information. The inserted content can be displayed according to a predetermined schedule. The inserted content can be displayed according to a randomization algorithm. The inserted content can be displayed according to a last played algorithm. The inserted content can be displayed based on priority of the content, such as, premium content sponsors having a higher priority over non-premium content sponsors. The inserted content can be displayed based on user preferences. The inserted content can be intrusive to the event, such as a spoken communication before, during, or after the call. The inserted content can be non-intrusive to the event, such as a passive display during a call.

It will be appreciated that the insertion of content into one or more of the events described herein provides the maximum opportunity to place content in front of a user without unnecessarily intruding on the user's communications experience, such as interrupting a call with a spam voice massage. Additionally, the insertion of content into one or more of the events described herein increases the overall impressions per user of the content over more traditional mobile marketing techniques, such as, SMS or WAP.

The inserted content can be downloaded periodically to the handset via a wireless communications network. The inserted content and display instructions can be inserted periodically via the control channel of a wireless communications network.

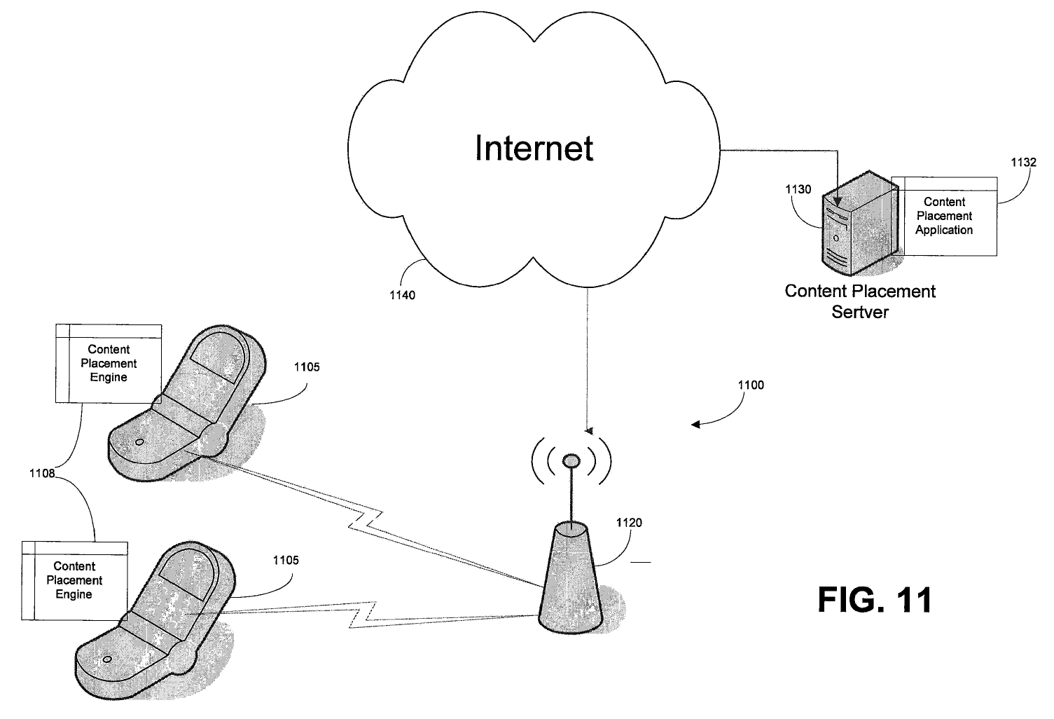

FIG. 11 illustrates an exemplary system architecture of an implementation of a mobile content system 1100, including one or more mobile telecommunications devices 1105 having a mobile content placement engine 1108 installed in local memory of the device 1105, a wireless network infrastructure 1120, a mobile content placement server 1130 having a mobile content placement application 1132, and a public network such as the Internet 1140.

Mobile content placement server 1130 includes a processor coupled to a computer readable memory, wherein the memory includes mobile content placement application 1132. Mobile content placement application 1108 is adapted to store and deliver one or more pieces of content to Mobile devices 1105 along with insertion and play instructions. Mobile content placement application 1132 is further adapted to receive information, such as measurements and use data, from mobile content placement engine 1108 regarding content actually displayed and user interactivity with the displayed content. Such information can include time of display, number of times displayed, and handset event associated with display. Mobile content placement server 1130 can include one or more secondary storage devices such as an external database (not shown). Mobile content placement server is in communication with wireless communication infrastructure 1120 via the internet or alternatively may be in direct communication with wireless network infrastructure 1120 via a private network.

Mobile telecommunications devices 1105 are configured to interface with wireless network infrastructure 1120. Generally, devices 1105 display one or more user interfaces relating to the operation and use of the telephone and experience one or more events between power-up and power-off (e.g., the events described previously in FIG. 3 and the associated displays and audible alarms). Mobile devices 1105 include mobile content placement engine 1108 stored in local memory in the device.

Mobile content placement engine 1108 is adapted to receive content, insertion instructions, and content display or play instructions from mobile content placement application 1132. Mobile content placement engine 1108 may receive insertion and display instructions periodically, randomly or on a just-in-time basis. Content, insertion instructions, and/or display instructions may be transmitted from the content placement server 1130 via the wireless network infrastructure 1120 to device 1105 during the power-up, power-off, a service provider update, and/or any other time the device 1105 is connected to the wireless network infrastructure 1120. Transmission of content, insertion instructions, and/or play instructions can be over the control frequency or any other frequency or frequency pair utilized by the wireless network infrastructure 1120.

Mobile content placement engine 1108 is adapted to insert received content into one or more events associated with the device between power-up and power off (e.g., the content insertion described previously in FIG. 6 and the associated displays and audible alarms). Mobile content placement engine 1108 is further adapted to record information related to the inserted content, including content actually inserted and displayed, time of display, user interactivity with display, user opt-in or opt-out of the inserted content, user deletion of the inserted content, user participation in a call to action associated with the inserted content, user return to or navigation to a WAP page associated with inserted content, or other user, content insertion, content display, or generally related marketing information.

Mobile content placement engine 1108 can transmit stored information related to the inserted data back to the content placement server 1130 over the wireless network infrastructure 1120. Transmission of the stored information related to the inserted data can be periodically, randomly, or on a just-in-time basis, such as in response to a prompt initiated by the content placement server 1130. Transmission of the stored information related to the inserted data can be at power-up, power-off, a service provider update, and/or any other time the device 1105 is connected to the wireless network infrastructure 1120. Transmission of the stored information related to the inserted data can be over the control frequency or any other frequency or frequency pair utilized by the wireless network infrastructure 1120.

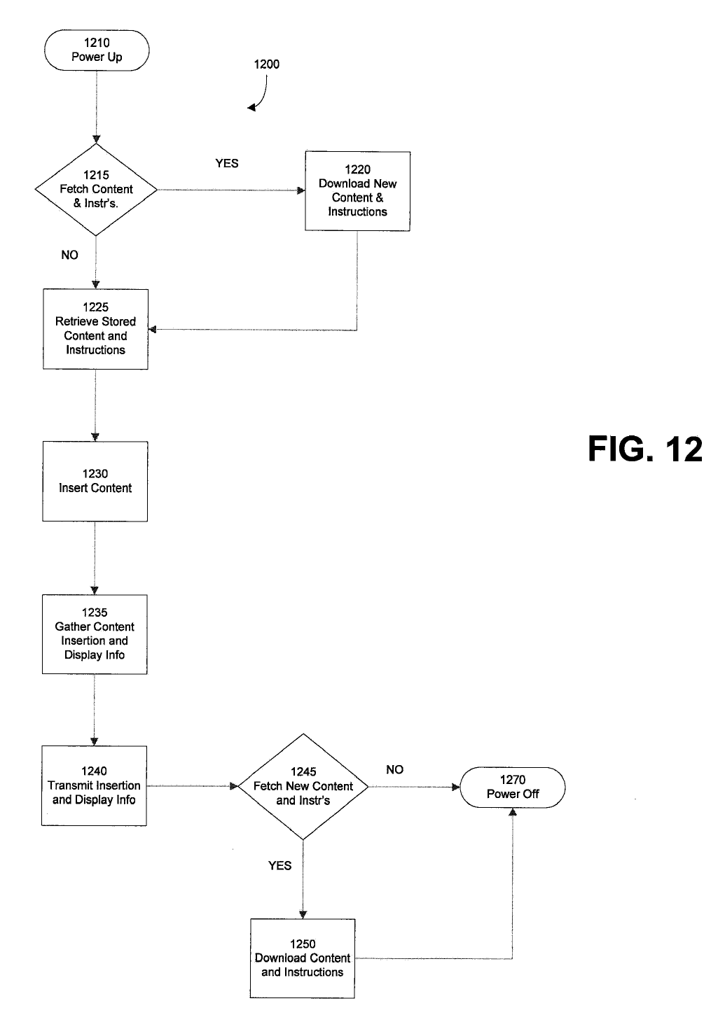

FIG. 12 is a flow chart 1200 of a process by which a mobile content placement engine installed on a mobile device retrieves, displays, and reports content displayed or otherwise played during one or more events in the operational lifecycle of a mobile device handset. Upon power-up 1210 of the mobile device the mobile content placement engine determines 1215 if content is stored locally in a cache or other local machine readable memory on the mobile device. If the stored content is missing, stale, or needs replacement or updating, the mobile content placement engine downloads 1220 new content and content display instructions from a content placement server connected to the handset by a wireless network infrastructure. The content placement engine then retrieves 1225 the stored content for play during one or more predetermined events in the operational lifecycle of the wireless device (e.g., the events of previously described in FIG. 3, and associated displays and/or audible alarms). Upon the occurrence of an event, the appropriate content is inserted 1230 into the device display or alarm function for user interaction (e.g., as previously described in FIG. 6 and associated displays and/or audible alarms). Upon insertion 1230 of the content, the mobile content placement engine stores or records 1235 relevant information relating to the content insertion. The relevant information can include the content displayed, user interaction with the content, time of display of the content, type of event preceding the content display, duration of the content display, intrusiveness of the content insertion, user opt in or opt out of the content display, user deletion of the content display, or other information associated with the user or content display.

The information recorded at 1235 is stored or recorded locally in a cache or other machine readable memory until the content placement engine transmits 1240 the content information to a content placement server via a wireless network infrastructure. After transmission of the content information the content server is configured to calculate a reward value for the display and interaction with the inserted content. The mobile content placement server determines the reward value based on the frequency of display or interactivity of the inserted content. The reward value associated with the inserted content can be based on the relative intrusiveness of the content (e.g., more intrusive content forms having higher reward credit). The reward value can be based on the level of user interactivity associated with the inserted content (e.g., the user answers a consumer call to action, follows a link to a URL address or WAP page, sends a text message in reply to the inserted content, or saves the content for later use.

The reward value can be in the form of customer loyalty points, discounts, monetary value, additional content or additional services, for example, the reward value can be deposited as one or more loyalty points into a consumer loyalty account associated with the user. By way of further example, the reward value can be deposited as additional monetary value on a stored value card, such as a gift card. A still a further example, the reward can be in the form of a discount or coupon for additional content, services, or any other consumer product. And another example, the reward value can be in the form of additional content, such as a free game or ring tone. The reward value can be in the form of discounted service, such as free weekend calls.

The reward value can be deposited into a user account, user loyalty program or user profile. Methods of tracking and using mobile user loyalty programs are described in U.S. Patent Application Publication Nos. US 2006/0270478 and US 2006/0259361 incorporated herein by reference. Methods of using mobile value accounts are described in co-pending U.S. patent application entitled Mobile Stored Value Transfer System, U.S. application Ser. No. ______ (Attorney Docket No. 22573-005001), filed Oct. 29, 2007, and incorporated herein by reference.

The mobile content placement engine can determine 1245 if new content needs to be retrieved. If content is stale or otherwise needs to be replaced or augmented, content and insertion instructions can be downloaded 1250 from the content placement server via a wireless communication network and stored locally on the wireless device for insertion in future events. Ultimately the device is powered-off 1270.

What is claimed herein is:

1. A computer implemented method of placing content on a mobile device, comprising:
retrieving content via a wireless communication network;
storing content locally on a mobile device;
displaying content in response to an event;
recording information associated with the content display; and
transmitting the content information via a wireless communication network.

2. The method of claim 1 wherein the content comprises auditory, graphic or textual information.

3. The method of claim 1 wherein the content is associated with a marketing campaign.

4. The method of claim 1 wherein in the content is interactive.

5. The method of claim 1 wherein retrieving content occurs at power-up.

6. The method of claim 1 wherein retrieving content occurs via a control frequency.

7. The method of claim 1 wherein retrieving content occurs on a predetermined basis.

8. The method of claim 1 wherein the content is displayed according to a last played algorithm.

9. The method of claim 1 wherein the event comprises a power-up display; a power-up audible alarm; a welcome screen; a ringtone; an alarm; a display during an idle handset period; a wallpaper; a status message; a user entered key stroke; receiving a telephone call, email, or SMS/MMS message; a voice communication or telephone call; intermittent intervals during a telephone call; sending an SMS/MMS message; sending an email; displaying an SMS/MMS message; displaying an email; inbox status displays; message displays; auxiliary application initiation screens; auxiliary application termination screens; power-off screens; and power-off alarms.

10. The method of claim 1 wherein the content information recorded comprises content display information, display time, user interactivity, or content intrusiveness.

11. The method of claim 1 further comprising rewarding a user for content displayed,

12. The method of claim 11 wherein the reward is associated with a consumer loyalty program.

13. The method of claim 11 wherein the reward is value added to a user account.

14. The method of claim 12 wherein the reward is content or services associated with the mobile device.

15. The method of claim 12 wherein the reward is associated with a stored value card.

16. The method of claim 12 wherein the reward is associated with a consumer coupon.

17. A system comprising:
a wireless network infrastructure;
a server configured to provide content and display instructions by communication via the wireless network infrastructure;
a wireless device handset configured to receive content and display instructions via the wireless network infrastructure, wherein the content is displayed on the wireless handset device in response to an event.

18. The system of claim 17 wherein the content comprises auditory, graphic or textual information.

19. The system of claim 17 wherein the content is associated with a marketing campaign.

20. The system of claim 17 wherein in the content is interactive.

21. The system of claim 17 wherein the event comprises a power-up display; a power-up audible alarm; a welcome screen; a ringtone; an alarm; a display during an idle handset period; a wallpaper; a status message; a user entered key stroke; receiving a telephone call, email, or SMS/MMS message; a voice communication or telephone call; regular or intermittent intervals during a telephone call; sending an SMS/MMS message; sending an email; displaying an SMS/MMS message; displaying an email; inbox status displays; message displays; auxiliary application initiation screens; auxiliary application termination screens; power-off screens; and power-off alarms.

22. The system of claim 17 wherein the wireless device is further configured to record information associated with content displayed, the information recorded comprises content display information.

23. The system of claim 22 further wherein the wireless device is further configured to transmit the recorded information via the wireless network infrastructure to the server.

24. The system of claim 23 wherein the server is further configured to reward a consumer based on the transmitted recorded information.

25. The system of claim 24 wherein the reward is associated with a consumer loyalty program.

26. The system of claim 24 wherein the reward is content or services associated with the wireless device.

27. The system of claim 24 wherein the reward is a coupon.

28. The system of claim 20 wherein the reward is value added to a user account.

29. A computer implemented method of advertising on a mobile device, comprising:
storing one or more advertisements on a mobile device having a display;
displaying the one or more advertisements on the mobile device display in response to one or more events;
recording information relating to the display of the one or more advertisements; and
rewarding a user, wherein the reward is based on the recorded information.

30. The method of claim 29 further comprising:
transmitting the recorded information via a wireless network infrastructure; and
updating the stored one or more advertisements using a transmission via a wireless network infrastructure.

31. A content distribution system for the mobile environment comprising:
a wireless communications infrastructure;
a network;
a server configured to transmit advertisements for content over the wireless communications infrastructure and network;
a wireless device having a display and configured to receive advertisements for content via the wireless communication infrastructure and store advertisements for content, wherein the content is interactive and configured to connect the user to the network.

32. The system of claim 31 wherein the device is further configured to display the advertisement for content in response to an event.

33. The system of claim 31 wherein the connection is via a link to a URL address.

34. The system of claim 33 wherein the device is further configured to record information associated with the displayed content and transmit the recorded information to the server.

35. The system of claim 33 wherein the server is configured to reward a user associated with the mobile device, the reward comprising an increase in value to a customer loyalty program.
